(19) United States
(12) Patent Application Publication
(10) Pub. No.: US 2019/0312423 A1
(43) Pub. Date: Oct. 10, 2019

(54) LOW-VOLTAGE PROTECTIVE DEVICE

(71) Applicant: Eaton Intelligent Power Limited, 4 Dublin (IE)

(72) Inventor: Kenan Askan, Vienna (AT)

(21) Appl. No.: 16/373,690

(22) Filed: Apr. 3, 2019

(30) Foreign Application Priority Data
Apr. 6, 2018 (DE) 10 2018 108 138.3

(51) Int. Cl. H02H 3/05; H02H 3/10

(52) U.S. Cl. CPC H02H 3/05; H02H 3/105

(57) ABSTRACT

A low-voltage protective device includes: at least one first outer conductor path from an outer conductor power supply connection of the low-voltage protective device to an outer conductor load connection of the low-voltage protective device; a mechanical bypass switch arranged in the outer conductor path; a first semiconductor circuit arrangement of the low-voltage protective device connected in parallel to the mechanical bypass switch, the first semiconductor circuit arrangement including at least one power semiconductor; a control and driver unit for driving the first semiconductor circuit arrangement with a control voltage, the control and driver unit being connecting the first semiconductor circuit arrangement, in a normal operation of the low-voltage protective device, with a first voltage value of the control voltage, the first voltage value being less than a peak control voltage of the power semiconductor. The control and driver unit is configured to increase the control voltage.

### CROSS-REFERENCE TO PRIOR APPLICATION

Priority is claimed to German Patent Application No. DE 10 2018 108 138.3, filed on Apr. 6, 2018, the entire disclosure of which is hereby incorporated by reference herein.

### FIELD

The invention relates to a low-voltage protective device.

### BACKGROUND

A hybrid low-voltage protective device is known from WO 2015/028634 A1 of the applicant. Thereby, an IGBT/diode circuit is arranged in parallel to a bypass switch. To switch off a current, the bypass switch is opened, thereby causing the current to commutate to the IGBT circuit via the low-voltage protective device. Subsequently, the current is switched off by means of the IGBT circuit.

The IGBT circuit is constantly energized in this case. It is intended that saturation of the IGBT occurs in the event of a short circuit (page 11, lines 10 to 15). This is detected by the IGBT driver, and the IGBT is subsequently de-energized.

It has been found that the IGBT circuit in such a low-voltage protective device is heavily loaded, reducing its service life. Since protective devices must function reliably over decades, this is extremely problematic. The desaturation of the collector-emitter voltage when a short-circuit is de-energized leads to a limitation of the maximum current through the IGBT, to a rapid increase in power loss, and can result in thermal overload of the IGBT, which can lead to a total loss of the IGBT. However, to make it possible to reliably de-energize high short-circuit currents, a corresponding concept uses a plurality of IGBTs connected in parallel. Although this solves the problems in terms of current carrying capacity of the overall arrangement, and in terms of thermal overload, it nonetheless results in a much more complex and component-intensive construction. Furthermore, this increases the loop inductance, which in turn increases the commutation time of a current in the event of a short circuit—accordingly creating numerous new problems.

### SUMMARY

In an embodiment, the present invention provides a low-voltage protective device, comprising: at least one first outer conductor path from an outer conductor power supply connection of the low-voltage protective device to an outer conductor load connection of the low-voltage protective device; a mechanical bypass switch arranged in the outer conductor path; a first semiconductor circuit arrangement of the low-voltage protective device connected in parallel to the mechanical bypass switch, the first semiconductor circuit arrangement comprising at least one power semiconductor; a control and driver unit configured to drive the first semiconductor circuit arrangement with a control voltage, the control and driver unit being configured to connect the first semiconductor circuit arrangement, in a normal operation of the low-voltage protective device, with a first voltage value of the control voltage, the first voltage value being less than a peak control voltage of the power semiconductor, wherein the control and driver unit is configured to increase the control voltage from the first voltage value to a second voltage value upon detection of a short-circuit current or an overcurrent in a first step, the second voltage value being greater than the peak control voltage of the power semiconductor, and to subsequently de-energize the first semiconductor circuit arrangement in a second step.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of a low-voltage protective device according to the invention; and

FIG. 2 shows details of a low-voltage protective device according to FIG. 1.

### DETAILED DESCRIPTION

In an embodiment, the present invention provides a low-voltage protective device of the type mentioned at the outset, which enables avoiding the named disadvantages, and which has a long service life and compact size.

As a result, even high short-circuit currents can be reliably de-energized with only a single power semiconductor component, such as an IGBT or MOSFET, without causing thermal problems or impacting the service life of the low-voltage protective device. Of course, the invention also enables reliably de-energizing overcurrents which are lower than a short-circuit current.

In this way, it is possible to reliably prevent a desaturation state of the voltage when an overcurrent or a short-circuit current is switched off. Since no desaturation occurs in the power semiconductor, it can also transmit a correspondingly high current with low power loss. In this case, the lifetime of the power semiconductor is by no means reduced by the excessive increase of the gate voltage relative to the peak gate voltage of the IGBT or MOSFET. The corresponding values of the peak gate voltage are always defined in the data sheets for continuous operation of the respective component. However, since the presently-described increase in the gate voltage only occurs very briefly, and only when an overcurrent or short circuit—which occurs relatively rarely—is de-energized, the power semiconductor is only operated at the overly-high gate voltage for a few milliseconds during a typical 20 to 25 year service life of the low-voltage protective device. This does not reduce the service life of the power semiconductor. The result is that the service life of a low-voltage protective device can be prolonged.

Furthermore, by using only a single power semiconductor component, the conduction paths can be kept short and thus the loop inductance can be kept low, whereby a short-circuit current commutates faster to the power semiconductor. As a result, the time period during which the power semiconductor is loaded can be further reduced, and the service life can be further increased.

The invention further relates to a method for operating a low-voltage protective device.

Embodiments of the invention allow achievement of the advantages inherent in the low-voltage protective device.

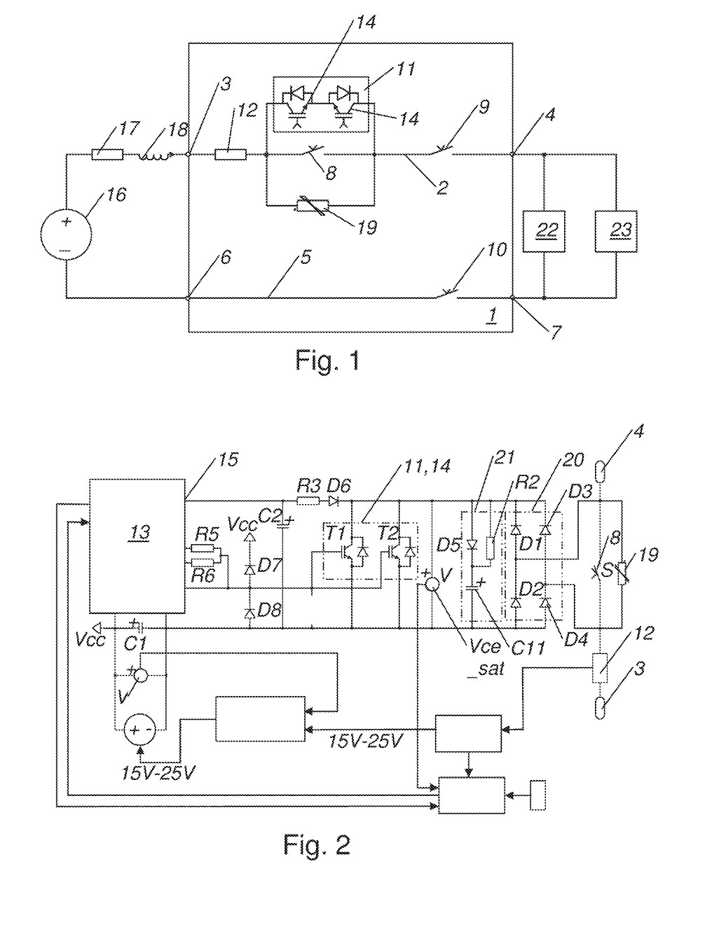

FIG. 1 shows a low-voltage protective device 1, having at least one first outer conductor path 2 from an outer conductor power supply connection 3 of the low-voltage protective device 1 to an outer conductor load connection 4 of the low-voltage protective device 1, wherein a mechanical bypass switch 8 is arranged in the outer conductor path 2, wherein a first semiconductor circuit arrangement 11 of the low-voltage protective device 1 is connected in parallel to the bypass switch 8, wherein the first semiconductor circuit arrangement 11 comprises at least one power semiconductor, wherein the low-voltage protective device 1 comprises a control and driver unit 13 for driving the first semiconductor circuit arrangement 11 with a control voltage, wherein the control and driver unit 13 is designed to connect the first semiconductor circuit arrangement 11, in a normal operation of the low-voltage protective device 1, at a first voltage value of the control voltage, wherein the first voltage value is less than a peak control voltage of the power semiconductor, wherein the control and driver unit 13 is designed to increase the control voltage from the first voltage value to a second voltage value upon detection of a short-circuit current or an overcurrent in a first step, wherein the second voltage value is greater than the peak control voltage of the power semiconductor, and to subsequently de-energize the first semiconductor circuit arrangement 11 in a second step.

It is particularly preferred that the at least one power semiconductor is at least one IGBT 14 or MOSFET, that the control voltage is a gate voltage of the IGBT 14 or MOSFET, and that the peak control voltage is a peak gate voltage of the IGBT 14 or MOSFET. The invention will be described below with reference to these preferred embodiments. However, the use of other power semiconductors—in particular, the use of bipolar transistors—can also be contemplated.

The present invention also makes it possible to reliably de-energize high short-circuit currents with only a single power semiconductor component, such as an IGBT 14 or MOSFET, without causing thermal problems or impacting the service life of the low-voltage protective device 1. Of course, the invention also enables reliably de-energizing overcurrents which are lower than a short-circuit current.

In this way, it is possible to reliably prevent a desaturation state of the voltage when an overcurrent or a short-circuit current is de-energized. Since no desaturation occurs in the power semiconductor, it can also transmit a correspondingly high current with low power loss. In this case, the service life of the power semiconductor is by no means reduced by the excessive increase of the gate voltage relative to the peak gate voltage of the IGBT 14 or MOSFET. The corresponding values of the peak gate voltage are always defined in the data sheets for continuous operation of the respective component. However, since the presently-described increase in the gate voltage only occurs very briefly, and only when an overcurrent or short circuit—which occurs relatively rarely—is de-energized, the power semiconductor is only operated at the overly-high gate voltage for a few milliseconds during a typical 20 to 25 year service life of the low-voltage protective device. This does not reduce the service life of the power semiconductor. The result is that the service life of a low-voltage protective device can be prolonged.

Furthermore, by using only a single power semiconductor component, the conduction paths can be kept short and thus the loop inductance can be kept low. As a result, a short-circuit current commutates faster to the power semiconductor. As a result, the time period during which the power semiconductor is loaded can be further reduced, and the service life can be further increased.

The present switching device is a low-voltage protective device 1. Low voltage is, as usual, the range up to 1000V AC and/or 1500V DC.

The low-voltage protective device 1 has at least one outer conductor path 2 and a neutral conductor path 5. For direct current, two conductor paths of different polarity are accordingly provided. The outer conductor path 2 runs through the low-voltage protective device 1 from an outer conductor power supply connection 3 to an outer conductor load connection 4. The neutral conductor path 5 runs through the low-voltage protective device 1 from a neutral connection 6 to a neutral load connection 7. The respective connections 3, 4, 6, 7 are preferably each designed as screw connection terminals and/or plug-in terminals, and are arranged in the low-voltage protective device 1 in a manner allowing access from the outside.

The low-voltage protective device 1 preferably has—at least in sections—a housing of insulating material.

A mechanical bypass switch 8 is arranged in the outer conductor path 2.

In the low-voltage protective device 1 as shown, a first mechanical disconnecting switch 9 is furthermore arranged in series with the bypass switch 8 in the outer conductor path 2. A second mechanical disconnecting switch 10 is preferably arranged in the neutral conductor path 5. The two disconnecting switches serve to ensure galvanic isolation.

A semiconductor circuit arrangement 11 is connected in parallel to the bypass switch 8.

The semiconductor circuit arrangement 11 is designed as a four-quadrant switch. In the present case, this is shown with back-to-back IGBTs 14, although the use of other IGBTs 14 or even MOSFETs can be contemplated as well. Accordingly, there is only and/or exactly one IGBT 14 for each half-wave.

The IGBTs 14 and/or MOSFETs are driven by a control and driver unit 13 of the low-voltage protective device 1, which is preferably designed comprising a microcontroller and/or microprocessor.

The control and driver unit 13 is designed to control the bypass switch 8 and the semiconductor circuit arrangement 11, as well as the—preferably provided—first mechanical disconnecting switch 9 and the—preferably provided—second mechanical disconnecting switch 10—and therefore to actuate and/or switch the same in a definable manner. For this purpose, the control and driver unit 13 is connected to the semiconductor circuit arrangement 11, and also to particularly-electromagnetic actuator elements of the first mechanical disconnecting switch 9 and the second mechanical disconnecting switch 10, preferably by circuitry. The control and driver unit 13 is not illustrated in FIG. 1. FIG. 2 shows an expanded context of the control and driver unit 13 in the circuit, wherein not all modules are indicated by reference numerals.

The power semiconductors—in particular, the IGBTs 14—are incorporated into a diode rectifier circuit. In FIG. 1, this is implemented by back-to-back IGBTs. In FIG. 2, this is implemented by a classic diode bridge circuit.

Furthermore, the low-voltage protective device 1 preferably has a rectifier circuit 20, which is also connected in parallel to the bypass switch 8. This is shown only in FIG. 2.

A snubber circuit 21 is likewise shown only in FIG. 2.

Furthermore, an overvoltage arrester and/or varistor 19 is connected in parallel to the bypass switch 8.

The low-voltage protective device 1 further comprises a current measuring arrangement 12 which is arranged in the outer conductor path 2 and which is preferably designed comprising a shunt resistor.

The current measuring arrangement 12 is connected to the control and driver unit 13 of the low-voltage protective device 1.

In addition to the current measuring arrangement 12, the control and driver unit 13 is further designed to detect desaturation of the IGBT 14 or MOSFET. This has already been described in the applicant's WO 2015/028634 A1. For this purpose, the control and driver unit 13 has a correspondingly wired input, which is indicated as the desaturation detection 15. As a result, an overload current or a short-circuit current can also be detected as it arises, and subsequently the low-voltage protective device 1 can be de-energized. This is particularly relevant if the low-voltage protective device 1 will be put into operation under pre-existing overload and/or short-circuit conditions.

In FIG. 1, in addition to the actual low-voltage protective device 1, the electrical context is also indicated. The power grid is illustrated as the AC/DC grid voltage source 16, the internal line resistance 17, and the grid inductance 18. Furthermore, an electrical load 23 and an electrical fault 22 in the form of a short circuit are shown.

The low-voltage protective device 1 is switched on as described in the applicant's WO 2015/028634 A1. The semiconductor circuit arrangement 11 is energized in the process.

The power semiconductor is operated, in normal operation, with a control voltage and/or gate voltage having a first voltage value, wherein the first voltage value is lower than a peak control voltage and/or a peak gate voltage of the power semiconductor and/or the IGBT 14 or MOSFET.

In particular, the first voltage value is as low as possible, and is only slightly above a gate threshold voltage of the IGBT 14 or MOSFET. The first voltage value of the control voltage and/or gate voltage is preferably between 100% and 150%—in particular, between 110% and 130%—of a threshold control voltage of the power semiconductor and/or a gate threshold voltage of the IGBT 14 or MOSFET. Typically, the gate threshold voltage is between 5V and 7V for an IGBT, and 3V to 4V for a MOSFET. These low voltage values extend the service life of the power semiconductor.

If a short circuit is already present at start-up, this is detected by the desaturation detection 15. Since the current at which the desaturation occurs also decreases as the gate voltage decreases, such a short circuit is detected more quickly than if the semiconductor circuit arrangement 11 is switched on with a high gate voltage. As a result, the short circuit can be detected and de-energized more quickly. It has been shown that, in this case, a short circuit is detected more quickly via the desaturation detection 15 than via the current measuring arrangement 12. After detection of desaturation, the semiconductor circuit arrangement 11 is de-energized directly by the control and driver unit 13, without a prior increase in the control voltage.

However, it has proven to be particularly advantageous in this context if the power semiconductor is only energized, during the switching-on process, for a so-called turn-on time which is preferably between 50 μs and 500 μs—in particular, substantially 100 μs—with a control voltage which has a third voltage value which is in an intermediate range between the threshold control voltage and the peak control voltage. Subsequently, the control voltage is lowered to the first voltage value. In particular, the third control voltage is between 40% and 60% of the peak control voltage. This can prevent unintentional activation during the switching-on, which can result from so-called peak currents and/or inrush currents.

If there is no fault, the bypass relay 8 is closed and the semiconductor circuit arrangement 11 remains energized with the gate voltage at a first voltage value.

To cut out the low-voltage protective device 1 when there is a prevailing current which corresponds at most to the intended operating current, the control and driver unit 13 activates the bypass relay 8 to open the contacts, whereupon the load current commutates completely to the semiconductor circuit arrangement 11.

As soon as the contacts of the bypass relay 8 reach a sufficient gap distance, the semiconductor circuit arrangement 11 is de-energized. For this purpose, there is a first waiting time. It is possible to assume that after this first waiting time, which can be easily determined experimentally, the contacts of the bypass relay 8 have reached the necessary gap distance. The voltage peaks produced by the de-energizing process are reduced in the varistor 19 and/or snubber 21. Subsequently, the disconnecting switches 9, 10 are opened.

Once a short circuit or overcurrent has been detected, the control and driver unit 13 causes the opening of the bypass relay 8 by activating the same accordingly. Simultaneously, in a first step, the control and driver unit 13 increases the gate voltage of the semiconductor circuit arrangement 11 from the first voltage value to a second voltage value, the second voltage value being greater than the peak gate voltage of the IGBT 14 or MOSFET. The power semiconductor reacts so quickly in this case that the higher control voltage already prevails before the current commutates.

The second voltage value is preferably between 120% and 170%—in particular, between 130% and 160%—of the peak control voltage of the power semiconductor. In particular, in the preferred embodiment of the power semiconductor as an IGBT 14 or MOSFET, the second voltage value is preferably between 120% and 170%—in particular, between 130% and 160%—of the peak gate voltage of the IGBT 14 or MOSFET. Given a common peak gate voltage of 20V in an IGBT, this corresponds to typical voltages between 24V and 34V.

Power semiconductors are able to cope with such high gate voltages arising during infrequent switching operations. Due to these high gate voltages, desaturation does not occur even at high currents through the IGBT 14 or MOSFET, and the IGBT 14 or MOSFET is operated at saturation.

The opening of the bypass relay 8 and the increase in the gate voltage can substantially occur simultaneously, since the increase of the gate voltage occurs much more quickly than the opening of the bypass relay 8.

After the contacts of the bypass relay 8 have reached a sufficient gap distance, the control and driver unit 13 de-energizes the semiconductor circuit arrangement 11 in a subsequent second step. For this purpose, the control and driver unit 13 preferably waits for a definable and/or previously specified first period of time before it carries out the second step. This makes it possible to ensure that the bypass relay 8 has opened, and the current is fully commutated to the semiconductor circuit arrangement 11 before it is de-energized.

The resulting voltage peaks are dissipated via the varistor 19 and/or snubber 21.

The control and driver unit 13 is designed to carry out the described steps in a corresponding method. In this case, upon detection of a short-circuit current or overcurrent, the control and driver unit 13 increases the gate voltage from the first voltage value to a second voltage value in a first step, wherein the second voltage value is greater than the peak gate voltage of the IGBT 14 or MOSFET, and the control and driver unit 13 de-energizes the semiconductor circuit arrangement 11 in a subsequent second step.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A low-voltage protective device, comprising:
at least one first outer conductor path from an outer conductor power supply connection of the low-voltage protective device to an outer conductor load connection of the low-voltage protective device;
a mechanical bypass switch arranged in the outer conductor path;
a first semiconductor circuit arrangement of the low-voltage protective device connected in parallel to the mechanical bypass switch, the first semiconductor circuit arrangement comprising at least one power semiconductor;
a control and driver unit configured to drive the first semiconductor circuit arrangement with a control voltage, the control and driver unit being configured to connect the first semiconductor circuit arrangement, in a normal operation of the low-voltage protective device, with a first voltage value of the control voltage, the first voltage value being less than a peak control voltage of the power semiconductor,
wherein the control and driver unit is configured to increase the control voltage from the first voltage value to a second voltage value upon detection of a short-circuit current or an overcurrent in a first step, the second voltage value being greater than the peak control voltage of the power semiconductor, and to subsequently de-energize the first semiconductor circuit arrangement in a second step.

2. The low-voltage protective device according to claim 1, wherein the at least one power semiconductor comprises at least one IGBT or MOSFET,
wherein the control voltage comprises a gate voltage of the IGBT or MOSFET, and
wherein the peak control voltage comprises a peak gate voltage of the IGBT or MOSFET.

3. The low-voltage protective device according to claim 1, wherein the first voltage value of the control voltage is between 100% and 150% of a threshold control voltage of the power semiconductor.

4. The low-voltage protective device according to claim 1, wherein the second voltage value is between 120% and 170% of the peak control voltage of the power semiconductor.

5. The low-voltage protective device according to claim 1, wherein the control and driver unit is configured to detect a desaturation of the power semiconductor, and to de-energize the semiconductor circuit arrangement after detection of desaturation.

6. The low-voltage protective device according to claim 1, wherein the control and driver unit is configured to wait for a definable first period of time between the first step and the second step.

7. A method for operating a low-voltage protective device, comprising:
providing at least one first outer conductor path;
arranging a mechanical bypass switch in the outer conductor path;
connecting a first semiconductor circuit arrangement of the low-voltage protective device in parallel to the mechanical bypass switch, the first semiconductor circuit arrangement comprising at least one power semiconductor;
providing a control and driver unit configured to drive the first semiconductor circuit arrangement with a control voltage;
using the control and driver unit to connect the first semiconductor circuit arrangement, in a normal operation of the low-voltage protective device, with a first voltage value of the control voltage, the first voltage value being less than a peak control voltage of the power semiconductor;
using the control and driver unit to increase the control voltage from the first voltage value to a second voltage value upon detection of a short-circuit current or an overcurrent in a first step, the second voltage value being greater than the peak control voltage of the power semiconductor; and
using the control and driver unit to de-energize the first semiconductor circuit arrangement in a subsequent, second step.

8. The low-voltage protective device according to claim 3, wherein the first voltage value of the control voltage is between 110% and 130% of the threshold control voltage of the power semiconductor.

9. The low-voltage protective device according to claim 4, wherein the second voltage value is between 130% and 160% of the peak control voltage of the power semiconductor.
